(19) United States
(12) Patent Application Publication
(10) Pub. No.: US 2024/0412442 A1
(43) Pub. Date: Dec. 12, 2024

(54) TWO-LEVEL BINNING PROCESS WITH DELAYED ATTRIBUTE SHADING

(71) Applicant: ADVANCED MICRO DEVICES, INC., Santa Clara, CA (US)

(72) Inventors: Vishrut Vaibhav, Oviedo, FL (US); Mangesh Prabhakar Nijasure, Orlando, FL (US)

(21) Appl. No.: 18/208,087

(22) Filed: Jun. 9, 2023

(51) Int. Cl. G06T 15/00; G06T 15/80

(52) U.S. Cl. CPC G06T 15/005; G06T 15/80

(57) ABSTRACT

An accelerated processing unit (APU) is configured to perform one or more attribute shading operations at a fragment shader. To this end, the APU includes a processor core configured to assemble one or more primitives from generated vertex shading data. The processor core culls one or more primitives to produce a set of surviving primitives and identifies which primitives of the set of surviving primitives are visible in a bin. The processor core then provides data identifying the visible primitives in the bin to a fragment shader. Based on the data identifying the visible primitives in the bin, the fragment shader generates attribute shading data for each visible primitive in the bin.

### BACKGROUND

To render three-dimensional scenes for display on two-dimensional displays, some graphics processing systems first receive a command stream from an application indicating vertices and attributes of various primitives to be rendered for the scene. The graphics processing systems then render these primitives according to a graphics pipeline that has different stages each including instructions to be performed by the graphics processing system. While rendering these scenes, some graphics processing systems are configured to perform attribute shading operations for the vertices indicated in the command stream to produce attribute shading data. After performing these attribute shading operations, the graphics processing systems then assemble one or more primitives from the vertices indicated in the command stream and cull one or more of the assembled primitives. Once the primitives are culled, the graphics processing systems then perform visibility checks, render one or more objects, or both based on the surviving primitives. However, because such graphics processing systems perform attribute shading operations before the primitives are culled, the graphics processing systems generate attribute shading data for vertices of culled primitives that goes unused, lowering the efficiency of these graphics processing systems.

### BRIEF DESCRIPTION OF THE DRAWINGS

The present disclosure may be better understood, and its numerous features and advantages are made apparent to those skilled in the art by referencing the accompanying drawings. The use of the same reference symbols in different drawings indicates similar or identical items.

FIG. 1 is a block diagram of a processing system configured for attribute shading at one or more fragment shaders during two-level binning, in accordance with some embodiments.

FIG. 2 is a block diagram of an accelerated processing unit configured to implement a graphics pipeline that includes attribute shading at one or more fragment shaders, in accordance with some embodiments.

FIG. 3 is a flow diagram of an example operation for attribute shading at one or more fragment shaders during two-level binning, in accordance with some embodiments.

FIG. 4 is a flow diagram of an example method for two-level binning that includes attribute shading at one or more fragment shaders, in accordance with some embodiments.

### DETAILED DESCRIPTION

To render primitives of an image in a screen space, some processing systems perform a two-level binning operation that includes a first binning pass (e.g., visibility pass) and a second pass (e.g., rendering pass). During the first pass of the two-level binning operation, an accelerated processing unit (APU) of a processing system first divides the screen space into two or more bins (e.g., coarse bins). The APU then determines whether each primitive of the image is visible (e.g., present) in each bin (e.g., each coarse bin). To determine whether a primitive is visible in a bin, some APUs first perform one or more shading operations (e.g., vertex shading, attribute shading, fragment shading) based on an index buffer associated with the image to be rendered that includes data indicating one or more vertices, attributes, or both of the image to be rendered. As an example, during a first pass (e.g., visibility pass) of a two-level binning operation, an APU includes a vertex shader configured to generate vertex shading data and attribute shading by performing one or more vertex shading operations and one or more attribute shading operations based on one or more vertices, attributes, or both indicated in an index buffer. After generating such vertex shading data and attribute shading data, the vertex shader is configured to store the vertex shading data in a position buffer and the attribute shading data in a parameter cache included in or otherwise connected to the APU. Within some processing systems, the vertex shader is also configured to cull one or more vertices, positions, or both from the vertex shading data before storing the vertex shader data in the position buffer. As an example, the vertex shader is configured to perform one or more culling operations to cull one or more vertices, positions, or both from the vertex shading data before storing the vertex shading data.

The APU includes a primitive assembler circuitry configured to assemble one or more primitives based on a set of vertices indicated in an index buffer, the generated vertex shading data, or both. Additionally, the primitive assembler circuitry of the APU is configured to cull one or more primitives from the assembled primitives to produce a set of surviving primitives by performing one or more culling operations (e.g., face culling, viewport culling, guard-band culling) on one or more assembled primitives. After the primitive assembly circuitry of the APU culls one or more primitives from the assembled primitives to produce a set of surviving primitives, the primitive assembler circuitry provides data (e.g., primitive IDs) identifying the primitives in the set of surviving primitives, data (e.g., pointers) indicating the vertex shading data of the vertices associated with (e.g., forming) the primitives in the set of surviving primitives, or both to a visibility circuitry of the APU. Such visibility circuitry, for example, includes hardware-based circuitry, software-based circuitry, or both configured to determine whether one or more primitives are visible in a tile of the screen space. For example, the visibility circuitry is configured to perform a visibility check for each primitive in the surviving set of primitives to determine whether each primitive in the set of surviving primitives is visible in a bin. To determine whether a primitive in the set of surviving primitives is in a bin (e.g., tile), the visibility circuitry performs one or more bounding box operations. In response to determining a primitive is not visible in a bin, the APU stores data indicating the primitive is not to be rendered in the bin, a draw call associated with the primitive is not to be performed for that bin, or both. Further, in response to determining a primitive is visible in a bin, the APU stores data (e.g., pointers) in a buffer that indicate the vertices, vertex shading data, attribute shading data, or any combination thereof of the visible primitive.

During the second pass (e.g., rendering pass) of the two-level binning operation, the APU uses the data indicating the vertices, vertex shading data, attribute shading data, or any combination thereof of a visible primitive determined during the first pass to rasterize the visible primitives and generate pixel values for the visible primitives in each bin (e.g., coarse bin). For example, the visibility circuitry passes pointers indicating the vertex shading data of the visible primitives stored in a position buffer and the attribute shading data of the visible primitives stored in a parameter cache to a fragment shader. The fragment shader then performs one or more fragment shading operations based on the indicated vertex shading data and attribute shading data. However, during such a two-level binning operation, attribute shading data for the vertices of the image is generated by the vertex shader before the primitive assembler circuitry culls the primitives. As such, the vertex shader generates attribute shading data for vertices of culled primitives that goes unused by the fragment shader when performing a visibility check of the surviving primitives. In this way, the processing system devotes resources to generating attribute shading data that goes unused, decreasing the processing efficiency of the processing system. Additionally, first storing such attribute shading data in the parameter cache before being retrieved by the fragment shader adds additional read and write cycles to the two-level binning operation, again decreasing processing efficiency.

To this end, techniques and systems disclosed herein are directed to a two-level binning operation that includes generating attribute shading data at a fragment shader. For example, during a first pass of a two-level binning operation, a vertex shader of an APU generates vertex shading data by performing one or more vertex shading operations based on one or more vertices indicated in an index buffer and saves such vertex shading data in the position buffer. Further, within some processing systems, the vertex shader or one or more other shaders are configured to perform one or more culling operations (e.g., face culling, viewport culling, guard-band culling) to cull one or more vertices, positions, or both from the vertex shading data before saving the vertex shading data in the position buffer. After the vertex shading data is stored in the position buffer, the primitive assembler circuitry of the APU then assembles one or more primitives based on the one or more vertices indicated in an index buffer, the vertex data stored in the position buffer, or both. Additionally, the primitive assembler circuitry culls one or more of the assembled primitives by performing one or more culling operations (e.g., face culling, viewport culling, guard-band culling) using the one or more vertices indicated in an index buffer, the vertex data stored in the parameter cache, or both to produce a set of surviving primitives. The primitive assembler circuitry then sends data indicating identifiers for the surviving primitives, vertex shading data associated with the vertices of the surviving primitives, or both to the visibility circuitry of the APU. The visibility circuitry then determines whether each primitive of the set of surviving primitives is visible in a bin (e.g., a tile) by, for example, performing one or more bounding box operations. For each primitive determined to be visible in the bin (e.g., for each visible primitive), the visibility circuitry sends data (e.g., primitive IDs) identifying the visible primitive to a fragment shader of the APU. Further, the APU also sends data indicating the index buffer to the fragment shader.

After receiving such data from the visibility circuitry, the fragment shader is configured to generate attribute shading data for the vertices associated with one or more visible primitives. For example, using data identifying the visible primitives from the visibility circuitry, the fragment shader identifies one or more vertices and one or more attributes from the index buffer. The fragment shader then generates attribute shading data based on the identified vertices and attributes. In this way, the fragment shader of the APU generates attribute shading data only for the vertices and attributes associated with visible primitives rather than generating attribute shading data for all the vertices and attributes identified in an index buffer. Because the fragment shader of the APU generates attribute shading data only for the vertices and attributes associated with visible primitives, the amount of unused attribute shading data generated by the APU is reduced, improving the processing efficiency of the processing system. Additionally, because the fragment shader generates attribute shading data for the visible primitives rather than retrieving such attribute shading data from the parameter cache, the number of read and write cycles is reduced, again improving the processing efficiency of the processing system.

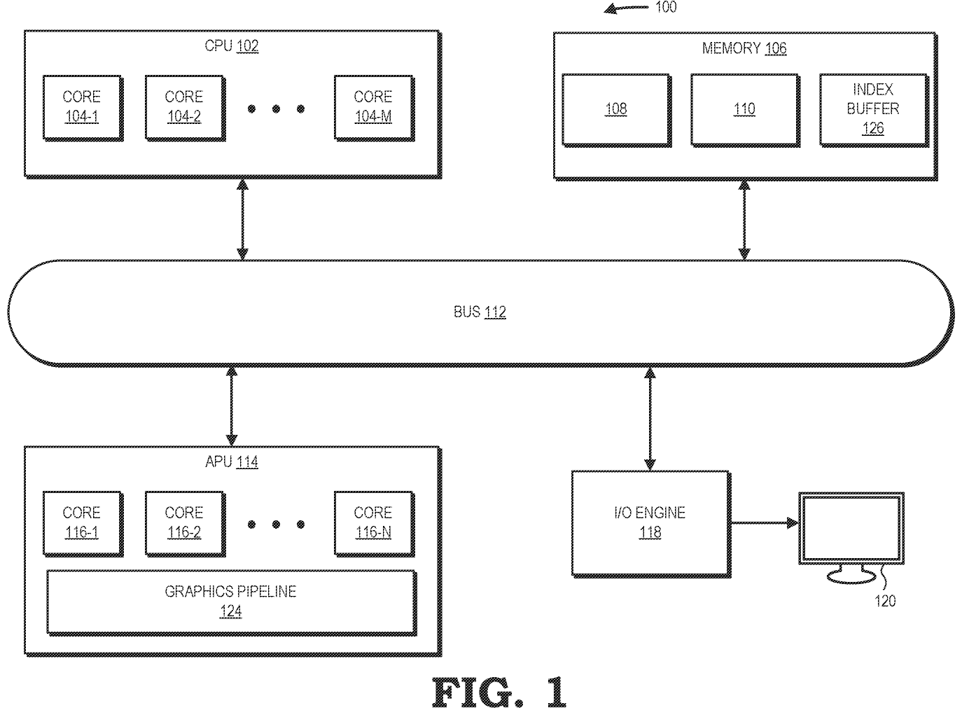

FIG. 1 is a block diagram of a processing system 100 configured to prime a depth buffer using hierarchical depth data, according to some implementations. The processing system 100 includes or has access to a memory 106 or other storage component implemented using a non-transitory computer-readable medium, for example, a dynamic random-access memory (DRAM). However, in implementations, the memory 106 is implemented using other types of memory including, for example, static random-access memory (SRAM), nonvolatile RAM, and the like. According to implementations, the memory 106 includes an external memory implemented external to the processing units implemented in the processing system 100. The processing system 100 also includes a bus 112 to support communication between entities implemented in the processing system 100, such as the memory 106. Some implementations of the processing system 100 include other buses, bridges, switches, routers, and the like, which are not shown in FIG. 1 in the interest of clarity.

The techniques described herein are, in different implementations, employed at accelerated processing unit (APU) 114. APU 114 includes, for example, vector processors, coprocessors, graphics processing units (GPUs), general-purpose GPUs (GPGPUs), non-scalar processors, highly parallel processors, artificial intelligence (AI) processors, inference engines, machine learning processors, other multithreaded processing units, scalar processors, serial processors, or any combination thereof. The APU 114 renders images according to one or more applications 110 for presentation on a display 120. For example, the APU 114 renders objects (e.g., textures) to produce values of pixels that are provided to the display 120, which uses the pixel values to display an image that represents the rendered objects. To render the objects, the APU 114 implements a plurality of processor cores 116-1 to 116-N that execute instructions concurrently or in parallel. For example, the APU 114 executes instructions from a graphics pipeline 124 using a plurality of processor cores 116 to render one or more textures. According to implementations, one or more processor cores 116 operate as SIMD units that perform the same operation on different data sets. Though in the example implementation illustrated in FIG. 1, three processor cores (116-1, 116-2, 116-N) are presented representing an N number of cores, the number of processor cores 116 implemented in the APU 114 is a matter of design choice. As such, in other implementations, the APU 114 can include any number of processor cores 116. Some implementations of the APU 114 are used for general-purpose computing. The APU 114 executes instructions such as program code 108 for one or more applications 110 stored in the memory 106 and the APU 114 stores information in the memory 106 such as the results of the executed instructions.

The processing system 100 also includes a central processing unit (CPU) 102 that is connected to the bus 112 and therefore communicates with the APU 114 and the memory 106 via the bus 112. The CPU 102 implements a plurality of processor cores 104-1 to 104-N that execute instructions concurrently or in parallel. In implementations, one or more of the processor cores 104 operate as SIMD units that perform the same operation on different data sets. Though in the example implementation illustrated in FIG. 1, three processor cores (104-1, 104-2, 104-M) are presented representing an M number of cores, the number of processor cores 104 implemented in the CPU 102 is a matter of design choice. As such, in other implementations, the CPU 102 can include any number of processor cores 104. In some implementations, the CPU 102 and APU 114 have an equal number of processor cores 104, 116 while in other implementations, the CPU 102 and APU 114 have a different number of processor cores 104, 116. The processor cores 104 execute instructions such as program code 108 for one or more applications 110 stored in the memory 106 and the CPU 102 stores information in the memory 106 such as the results of the executed instructions. The CPU 102 is also able to initiate graphics processing by issuing draw calls to the APU 114. In implementations, the CPU 102 implements multiple processor cores (not shown in FIG. 1 in the interest of clarity) that execute instructions concurrently or in parallel.

In embodiments, the APU 114 is configured to render one or more objects for an image to be rendered in a screen space according to a graphics pipeline 124. A graphics pipeline 124 includes, for example, one or more steps, stages, or instructions to be performed by APU 114 in order to render one or more objects for an image to be rendered. For example, a graphics pipeline 124 includes data indicating a vertex shader stage, hull shader stage, tessellator stage, primitive assembly stage, binner stage, rasterizer stage, pixel shader stage, and output merger stage to be performed by APU 114 in order to render one or more objects. According to embodiments, graphics pipeline 124 has a frontend that includes one or more stages of graphics pipeline 124 and a backend including one or more other stages of graphics pipeline 124. As an example, graphics pipeline 124 has a frontend including one or more stages associated a visibility pass (e.g., a first pass of a two-level binning operation) that includes, for example, a vertex shader stage, hull shader stage, tessellator stage, primitive assembly stage, binner stage, or any combination thereof and graphics pipeline 124 has a backend including one or more stages associated with a rendering pass (e.g., a second pass of a two-level binning operation) that includes, for example, a rasterizer stage, pixel shader stage, output merger stage, or any combination thereof. In embodiments, APU 114 is configured to perform at least a portion of the frontend of graphics pipeline 124 concurrently with at least a portion of the backend of graphics pipeline 124. For example, APU 114 is configured to perform one or more stages of a frontend of graphics pipeline 124 associated with coarse-bin rendering currently with one or more stages of a backend of graphics pipeline 124 associated with fine-bin rendering.

Further, to render one or more objects of an image in a screen space, APU 114 is configured to perform a two-level binning operation that includes a first pass (e.g., visibility pass) and a second pass (e.g., rendering pass). During the first pass, APU 114 first divides a screen space into two or more bins (e.g., coarse bins) and determines which primitives of the image to be rendered are visible in each bin. To this end, during the first pass, APU 114 is configured to use index data stored in an index buffer 126 to execute at least a portion of graphics pipeline 124 (e.g., a portion of graphics pipeline 124 associated with the first pass of a two-level binning operation). For example, APU 114 uses index data from index buffer 126 when executing the frontend of graphics pipeline 124 that includes stages associated with a visibility pass. Such index data stored in index buffer 126 includes, for example, data (e.g., pointers) representing vertices and attributes of one or more primitives of the image to be rendered by APU 114. As an example, index data stored in index buffer 126 includes pointers to data representing vertices, attributes, or both of one or more primitives of the image to be rendered stored in vertex buffers, attribute buffers, or both.

In embodiments, during the first pass, APU 114 is configured to provide data (e.g., a pointer, an address) indicating index buffer 126 to a vertex shader included in or otherwise connected to APU 114. Such a vertex shader, for example, includes hardware-based circuitry, software-based circuitry, or both configured to perform one or more vertex shading operations, attribute shading operations, or both. After receiving data indicating index buffer 126, the vertex shader is configured to identify one or more vertices, attributes, or both of one or more primitives to be rendered for an image based on, for example, data (e.g., instructions) received from one or more applications 110, graphics pipeline 124, or both. The vertex shader then performs one or more vertex shading operations and one or more attribute shading operations using the identified vertices and attributes to generate vertex shading data (e.g., the data resulting from the performance of one or more vertex shading operations) and attribute shading data (e.g., the data resulting from the performance of one or more attribute shading operations). Once the vertex shading data and the attribute shading data are generated, the vertex shader stores the vertex shading data in a position buffer (not shown for clarity) and the attribute shading data in a parameter cache (not shown for clarity) included in or otherwise connected to APU 114. In some embodiments, the vertex shader or one or more other shaders of the APU are configured to cull one or more vertices, position, or both from the vertex shading data before it is stored in the position buffer. For example, the vertex shader, one or more other shaders, or both perform one or more culling operations (e.g., face culling, viewport culling, guard-band culling) to cull one or more to cull one or more vertices, position, or both from the vertex shading data before storing the vertex shading data.

Additionally, during a first pass of a two-level binning operation, APU 114 is configured to provide data (e.g., a pointer, an address) indicating index buffer 126 to a primitive assembly circuitry included in or otherwise connected to APU 114. The primitive assembly circuitry, for example, includes hardware-based circuitry, software-based circuitry, or both configured to assemble one or more primitives, cull one or more primitives, or both. As an example, in some embodiments, the primitive assembly circuitry is configured to first retrieve vertex shading data from the parameter cache based on vertices indicated in index buffer 126, instructions received from one or more applications 110, or both. The primitive assembly circuitry is then configured to assemble one or more primitives (e.g., triangles) using the retrieved vertex shading data, one or more vertices indicated in index buffer 126, or both. Further, after assembling one or more primitives, the primitive assembly circuitry is configured to cull one or more of the assembled primitives to produce a set of surviving primitives. To this end, primitive assembly performs one or more culling operations (e.g., face culling, viewport culling, guard-band culling) on one or more assembled primitives to produce a set of surviving primitives. After determining a set of surviving primitives, the primitive assembler circuitry provides data indicating the primitives (e.g., primitive IDs), data (e.g., pointers) indicating the vertex shading data and attribute shading data associated with the vertices of the primitives in the set of surviving primitives, or both to a visibility circuitry of APU 114. Such a visibility circuitry includes, for example, hardware-based circuitry, software-based circuitry, or both configured to determine whether one or more primitives are visible in a tile of the screen space. To determine whether a primitive of the set of surviving primitives is visible in a tile, the visibility circuitry is configured to perform one or more bounding box operations using the data indicating the primitives in the set of surviving primitives (e.g., primitive IDs), data (e.g., pointers) indicating the vertex shading data associated with the vertices of the primitives in the set of surviving primitives, or both. In response to determining that a primitive is not visible in a bin, the visibility circuitry generates data indicating that the primitive is not to be drawn in the bin, a draw call associated with the primitive is not to be performed for the bin, or both. Further, in response to determining that a primitive is visible in a bin, the visibility circuitry stores vertex data associated with the vertices of the visible primitive, shading data (e.g., vertex shading data, attribute shading data) associated with the vertices of the visible primitive, or both in a buffer as compressed index data. In embodiments, the APU 114 subsequently flushes the buffer such that the vertex data associated with the vertices of the visible primitives, shading data (e.g., vertex shading data, attribute shading data) associated with the vertices of the visible primitives, or both is stored in memory 106 (e.g., in a compressed index buffer, in index buffer 126).

During a second pass (e.g., fine-bin pass, rendering pass) of the two-level binning operation, APU 114 is configured to render the pixels in each bin (e.g., coarse bin). To this end, a fragment shader included in or otherwise connected to APU 114 includes hardware-based circuitry, software-based circuitry, or both configured to perform one or more fragment shading operations (e.g., pixel shading operations) based on the vertex data associated with the vertices of visible primitives in a bin (e.g., primitives visible in the bin), shading data (e.g., vertex shading data, attribute shading data) associated with the vertices of the visible primitives in the bin, or both to rasterize the primitives in a bin, determine pixel values in the bin, perform pixel shading for pixels in the bin, or any combination thereof. For example, in embodiments the fragment shader is configured to retrieve vertex shading data for the visible primitives from a position buffer, retrieve attribute shading data for the visible primitives from the parameter cache, or both. Based on the retrieved vertex shading data and attribute shading data, the fragment shader then performs one or more fragment shading operations to rasterize the primitives in a bin, determine pixel values in the bin, perform pixel shading for pixels in the bin, or any combination thereof. In some embodiments, APU 114 is configured to perform a first pass of a two-level binning operation for a first bin (e.g., coarse bin) while performing a second pass (e.g., rendering pass) of a two-level binning operation for a second, different bin (e.g., coarse bin). In this way, APU 114 only renders primitives determined to be visible in a bin, reducing the time needed to render an image. However, in such a two-level binning operation, the vertex shader generates attribute shading data before the shaders, primitive assembly circuitry, and visibility circuitry cull one or more primitives to produce the visible primitives in a bin. As such, the vertex shader generates attribute shading data for primitives that are subsequently culled or not visible and such attribute shading data goes unused. Additionally, more resources than are required are used by the processing system 100 to generate such unused attribute shading data, decreasing the processing efficiency of the processing system 100. Further, requiring the fragment shader to retrieve attribute shading data from the parameter cache creates additional read and write cycles for a two-level binning operation, also decreasing the processing efficiency of the processing system 100.

To this end, processing system 100 is configured to generate attribute shading data at the fragment shader. For example, APU 114 is configured to perform a two-level binning operation that includes generating attribute shading data at a fragment shader. Such a two-level binning operation first includes the vertex shader first identifying one or more vertices of one or more primitives to be rendered for an image from index buffer 126 based on, for example, data (e.g., instructions) received from one or more applications 110, graphics pipeline 124, or both. The vertex shader then performs one or more vertex shading operations using the identified vertices to generate vertex shading data and stores the vertex shading data in a position buffer. According to some embodiments, the vertex shader, one or more other shaders, or both first perform one or more culling operations (e.g., face culling, viewport culling, guard-band culling) to cull one or more vertices, positions, or both from the vertex shading data before the vertex shading data is stored in the position buffer. Further, such a two-level binning operation includes the primitive assembly circuitry assembling one or more primitives (e.g., triangles) using the vertex shading data, one or more vertices indicated in index buffer 126, or both. Additionally, the primitive assembly circuitry culls one or more of the assembled primitives to produce a set of surviving primitives by performing one or more culling operations (e.g., face culling, viewport culling, guard-band culling). After determining a set of surviving primitives, the primitive assembler circuitry provides primitive data to the visibility circuitry that indicates identifiers for the primitives of the set of surviving primitives (e.g., primitive IDs), the vertex shading data associated with the vertices of the primitives in the set of surviving primitives, or both. The visibility circuitry then determines whether each primitive in the set of surviving primitives is visible in a bin by, for example, performing one or more bounding box operations using the data indicating identifiers for the primitives of the set of surviving primitives (e.g., primitive IDs), the vertex shading data associated with the vertices of the primitives in the set of surviving primitives, or both. For each primitive determined to be visible in a bin (e.g., for each visible primitive), the visibility circuitry provides visible primitive data indicating identifiers for the visible primitive (e.g., primitive IDs), the vertex shading data associated with the vertices of the visible primitive, or both to the fragment shader.

In response to receiving the visible primitive data from the visibility circuitry, the fragment shader generates attribute shading data for the vertices of the visible primitives. For example, based on the primitive identifiers of the visible primitive data, the fragment shader identifies one or more vertices and one or more attributes associated with the visible primitives from index buffer 126. The fragment shader then performs one or more attribute shading operations using the identified vertices and attributes to produce the attribute shading data for the vertices of the visible primitives. In this way, the fragment shader is configured to generate attribute shading data only for the vertices of the visible primitives rather than for the vertices of each primitive, reducing the amount of data that is processed and increasing the processing efficiency of processing system 100.

Additionally, having the fragment shader generate the attribute shading data rather than retrieve such data from the parameter cache reduces the number of read and write cycles in the two-level binning operation which also helps improve the processing efficiency of processing system 100.

According to embodiments, the fragment shader of APU 114 is configured to generate attribute shading data during a first pass (e.g., visibility pass) of a two-level binning operation, a second pass (e.g., rendering pass) of a two-level binning operation, or both. As an example, during a first pass of a two-level binning operation, a second pass of a two-level binning operation, or both, the visibility circuitry is configured to provide visible primitive data (e.g., data indicating identifiers for the visible primitives in a bin, the vertex shading data associated with the vertices of the visible primitives in a bin, or both) and data indicating index buffer 126 to the fragment shader. In response to receiving the visible primitive data and data indicating index buffer 126, the fragment shader identifies one or more vertices, attributes, or both of the visible from index buffer 126 based on the visible primitive data and generates attribute shading data for the vertices of the visible. Additionally, according to some embodiments, during a second pass of the two-level binning operation, after generating attribute shading data, the fragment shader performs one or more pixel shading operations for one or more rasterized primitives to generate one or more pixel values for the image.

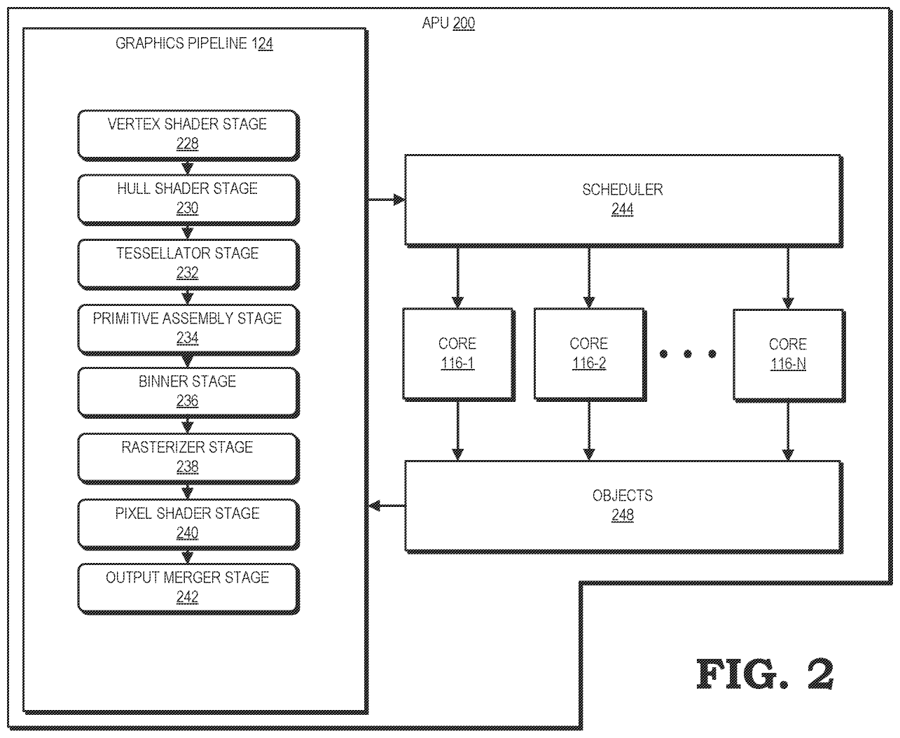

Referring now to FIG. 2, an APU 200 configured to implement a graphics pipeline is presented. In embodiments, APU 200, similar to or the same as APU 114, is configured to render one or more objects 248 based on a command stream indicating one or more instructions received from an application 110. For example, a command stream includes data indicating a batch of draw calls each identifying one or more primitives to be rendered for the image. To render the image indicated in the command stream, APU 200 is configured to render one or more primitives of a draw call according to graphics pipeline 124. Graphics pipeline 124 includes one or more steps, stages, or instructions to be performed by APU 200 in order to render one or more objects for an image to be rendered, for example, vertex shader stage 228, hull shader stage 230, tessellator stage 232, primitive assembly stage 234, binner stage 236, rasterizer stage 238, pixel shader stage 240, output merger stage 242, or any combination thereof. According to embodiments, one or more stages of graphics pipeline 124 (e.g., vertex shader stage 228, hull shader stage 230, tessellator stage 232, primitive assembly stage 234, binner stage 236) are associated with a first pass (e.g., visibility pass) of a two-level binning operation and one or more other stages of graphics pipeline 124 (e.g., rasterizer stage 238, pixel shader stage 240, output merger stage 242) are associated with a second pass (e.g., rendering pass) of the two-level binning operation.

Vertex shader stage 228 includes, for example, data and instructions for APU 200 to perform one or more operations on one or more vertices indicated in index buffer 126 to produce vertex shading data. Such operations include, for example, transformations (e.g., coordinate transformations, modeling transformations, viewing transformations, projection transformations, viewpoint transformations), skinning, morphing, and lighting operations. According to embodiments, vertex shading data generated during vertex shader stage 228 is stored in a parameter cache included in or otherwise connected to APU 200. Hull shader stage 230 and tessellator stage 232 together include, for example, data and instructions for APU 200 to implement tessellation for the vertices modified by vertex shader stage 228. Primitive assembly stage 234 includes, for example, data and instructions for APU 200 to assemble one or more primitives based on the vertices modified by vertex shader stage 228, hull shader stage 230, tessellator stage 232, or any combination thereof. For example, primitive assembly stage 234 includes APU 200 assembling one or more primitives based on vertex shading data generated during vertex shader stage 228. Additionally, primitive assembly stage 234 includes APU 200 culling one or more assembled primitives to produce a set of surviving primitives. For example, APU 200 is configured to perform one or more culling operations (e.g., face culling, viewport culling, guard-band culling) on one or more assembled primitives to produce a set of surviving primitives.

Binner stage 236 includes, for example, data and instructions for APU 200 to perform coarse rasterization to determine if one or more bins (e.g., coarse bins) of an image overlap with one or more primitives of the set of surviving primitives. That is to say, binner stage 236 includes data and instructions for APU 200 to determine which primitives are present (e.g., visible) in one or more bins (e.g., coarse bin) of an image. For example, binner stage 236 includes a fragment shader of APU 200 performing a visibility check for each primitive of the set of surviving primitives to determine which primitives are visible in a first bin. Additionally, in embodiments, binner stage 236 includes APU 200 generating attribute shading data. As an example, binner stage 236 includes a fragment shader of APU 200 generating attribute shading data for the vertices of the primitives of the set of surviving primitives. Rasterization stage 238 includes, for example, data and instructions for APU 200 to determine which pixels are included in each visible primitive (e.g., primitives visible in a bin) and convert each primitive into pixels of the image. Pixel shader stage 240 includes, for example, data and instructions for APU 200 to determine the output values for the pixels determined during rasterization stage 238. According to embodiments, pixel shader stage 240 includes APU 200 generating attribute shading data. As an example, pixel shader stage 240 includes a fragment shader of APU 200 generating attribute shading data for the vertices of the primitives of the visible primitives. Output merger stage 242 includes, for example, data and instructions for APU 200 to merge the output values of the pixels using, for example, z-testing and alpha blending.

According to embodiments, each instruction of a stage of graphics pipeline 124 is performed by one or more processor cores 116 of APU 200. Though the example embodiment illustrated in FIG. 2 presents APU 200 as having three processor cores (116-1, 116-2, 116-N) representing an N number of cores, in other embodiments, APU 200 may have any number of cores. Each instruction of graphics pipeline 124 is scheduled for execution by one or more processor cores 116 by scheduler 244. Scheduler 244 includes, for example, hardware-based circuitry, software-based circuitry, or both configured to schedule tasks and instructions for the processor cores 116 of APU 200. In this way, two or more stages of graphics pipeline 124 are performed concurrently. For example, in some embodiments, graphics pipeline 124 includes a frontend that includes one or more stages of graphics pipeline 124 and a backend that includes one or more other stages of graphics pipeline 124. As an example, graphics pipeline 124 includes a frontend that includes stages (e.g., vertex shader stage 228, hull shader stage 230, tessellator stage 232, primitive assembly stage 234, binner stage 236) associated with a first pass (e.g., visibility pass) of a two-level binning operation and a backend that includes stages (e.g., rasterization stage 238, pixel shader stage 240, output merger stage 242) relating to a second pass (e.g., rendering pass) of the two-level binning operation. In embodiments, APU 200 is configured to perform one or more stages of the frontend of graphics pipeline 124 concurrently with one or more stages of the backend of graphics pipeline 124.

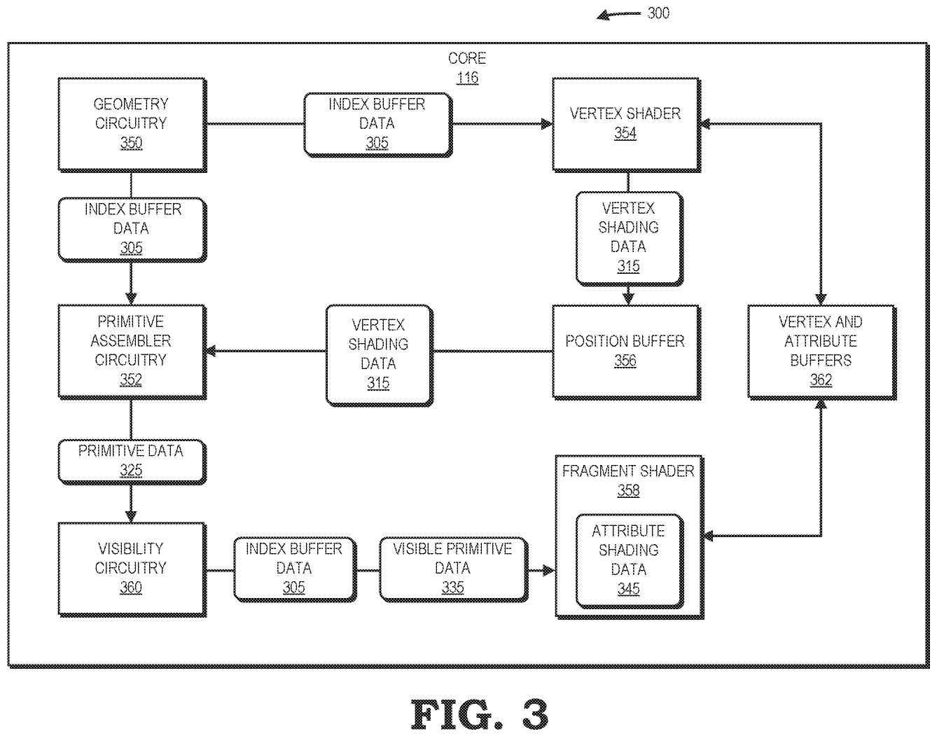

Referring now to FIG. 3, an example operation 300 for attribute shading at one or more fragment shaders during two-level binning is presented. According to some embodiments, example operation 300 is implemented during a first pass (e.g., visibility pass) of a two-level binning operation, a second pass (e.g., rendering pass) of a two-level binning operation, or both. In example operation 300 a processor core 116 of an APU (e.g., APU 114, 200) includes geometry circuitry 350. Geometry circuitry 350, for example, includes hardware-based circuitry, software-based circuitry, or both configured to perform one or more operations (e.g., shader operations) to render one or more objects 248. To this end, in example operation 300, geometry circuitry 350 is configured to provide index buffer data 305 to vertex shader 354 included in or otherwise connected to processor core 116. Such index buffer data 305, for example, includes data (e.g., an address, a pointer) indicating index buffer 126. Vertex shader 354, for example, includes hardware-based circuitry, software-based circuitry, or both configured to perform one or more vertex shading operations (e.g., coordinate transformations, modeling transformations, viewing transformations, projection transformations, viewpoint transformations). As an example, in embodiments, vertex shader 354 is configured to identify one or more vertices from index buffer 126 based on, for example, data (e.g., instructions) received from an application 110. For example, vertex shader 354 is configured to identify one or more vertices stored in a vertex buffer of vertex and attribute buffers 362 from index buffer 126. Vertex and attribute buffers 362, for example, represent respective vertex buffers and attribute buffers that store vertices and attributes for the primitives to be rendered for a scene. After identifying one or more vertices from index buffer 126, vertex shader 354 performs one or more vertex shading operations using the identified vertices to produce vertex shading data 315 (e.g., data resulting from the performance of one or more vertex shading operations using the identified vertices). Vertex shader 354 then stores vertex shading data 315 in position buffer 356 included in or otherwise connected to processor core 116. Additionally, in some embodiments, vertex shader 354 is configured to perform one or more culling operations (e.g., face culling, viewport culling, guard-band culling) to cull one or more vertices, positions, or both from vertex shading data 315 before storing vertex shading data 315 in position buffer 356.

Further, example operation 300 includes geometry circuitry 350 providing index buffer data 305 that includes data (e.g., address, pointer) indicating index buffer 126 to primitive assembly circuitry 352. Primitive assembly circuitry 352 includes, for example, hardware-based circuitry, software-based circuitry, or both configured to assemble one or more primitives, cull one or more primitives, or both. According to embodiments, primitive assembly circuitry 352 is configured to identify one or more vertices from index buffer 126 based on, for example, data (e.g., instructions) received from an application 110. In some embodiments, after identifying one or more vertices, primitive assembler circuitry 352 is configured to retrieve vertex shading data 315 from position buffer 356. As an example, primitive assembler circuitry 352 is configured to retrieve vertex shading data 315 associated with the identified vertices from position buffer 356. Example operation 300 also includes primitive assembler circuitry 352 assembling one or more primitives based on the vertices identified from index buffer 128, vertex shading data 315, or both. In response to assembling one or more primitives, primitive assembler circuitry 352 culls one or more of the assembled primitives to produce a set of surviving primitives. As an example, primitive assembler circuitry 352 performs one or more culling operations (e.g., face culling, viewport culling, guard-band culling) to produce the set of surviving primitives.

Example operation 300 also includes primitive assembly circuitry 352 providing primitive data 325 to visibility circuitry 360 included in or otherwise connected to processor core 116. Such primitive data 325, for example, includes one or more identifiers (e.g., primitive IDs) for the primitives of the set of surviving primitives, data (e.g., pointers) indicating vertex shading data 315 stored in position buffer 356 related to vertices of one or more primitives of the set of surviving primitives, or both. Visibility circuitry 360, for example, includes hardware-based circuitry, software-based circuitry, or both configured to determine whether one or more primitives of the set of surviving primitives is visible in a bin (e.g., a tile). As an example, visibility circuitry 360 is configured to determine whether each primitive of the set of surviving primitives is visible in a bin by performing one or more bounding box operations based on the primitive data 325. For each primitives of the set of surviving primitives determines to be visible in the bin, visibility circuitry 360 provides visible primitive data 335 to fragment shader 358. Such visible primitive data 335, for example, includes one or more identifiers (e.g., primitive IDs) for the visible primitives (e.g., primitives determined to be visible in a bin), data (e.g., pointers) indicating vertex shading data 315 stored in position buffer 356 related to vertices of one or more visible primitives, or both

Additionally, in some embodiments, example operation 300 includes geometry circuitry 350, visibility circuitry 360, or both providing index buffer data 305 to fragment shader 358. Fragment shader 358 includes hardware-based circuitry, software-based circuitry, or both configured to perform one or more fragment shading operations. In response to receiving visible primitive data 335, fragment shader 358 is configured to generate attribute shading data 345 based on primitive data 325. To this end, in some embodiments, fragment shader 358 is first configured to identify one or more vertices, attributes, or both stored in vertex and attribute buffers 362 from index buffer 126 based on visible primitive data 335. For example, fragment shader 358 identifies one or more vertices, attributes, or both associated with one or more visible primitives from index buffer 126 based on primitive identifiers of visible primitive data 335. As a further example, fragment shader 358 identifies one or more attributes associated with one or more vertices of the visible primitives from index buffer 126 based on visible primitive data 335. After identifying one or more vertices, attributes, or both from index buffer 126, fragment shader 358 performs one or more attribute shading operations using the identified vertices, identified attributes, or both to generate attribute shading data 345. Attribute shading data 345 includes, for example, data resulting from the performance of one or more attribute shading operations using the identified vertices, identified attributes, or both to generate attribute shading data 345. In this way, example operation 300 includes generating attribute shading data 345 at fragment shader 358 rather than vertex shader 354. As such, fragment shader 358 generates attribute data for the visible primitives (e.g., primitives visible in a bin) rather than generating attribute data for all the primitives, reducing the resources needed to generate attribute shading data and increasing the processing efficiency of processing system 100.

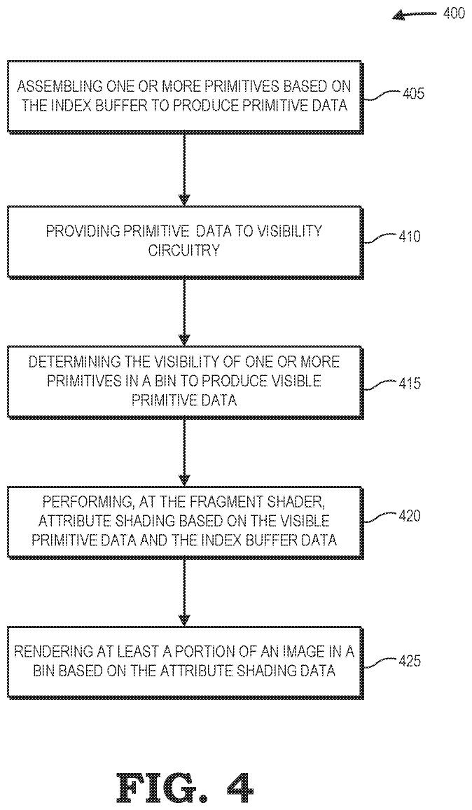

Referring now to FIG. 4, an example method 400 for two-level binning including attribute shading at one or more fragment shaders is presented, in accordance with some embodiments. At step 405 of example method 400, primitive assembler circuitry 352 included in or otherwise connected (e.g., via bus 112) to an APU (e.g., APU 114, 200) is configured to assemble one or more primitives based on index buffer 126. As an example, primitive assembler circuitry 352 is configured to identify one or more vertices from index buffer 126 based on, for example, data (e.g., instructions) received from one or more applications 110. Primitive assembler circuitry 352 then assembles one or more primitives based on the identified vertices. Additionally, primitive assembler circuitry 352 is configured to cull one or more of the assembled primitives to generate a set of surviving primitives by performing one or more culling operations (e.g., face culling, viewport culling, guard-band culling) using one or more assembled primitives. At step 410, after generating a set of surviving primitives, primitive assembly circuitry 352 is configured to provide the primitive data (e.g., primitive data 325) to visibility circuitry 360 included in other otherwise connected (e.g., via bus 112) to the APU. Such primitive data includes, for example, data indicating an identifier for each primitive of the set of surviving primitives, vertex shading data (e.g., vertex shading data 315) associated with the vertices of the primitives of the set of surviving primitives, or both.

At step 415, in response to receiving the primitive data, visibility circuitry 360 is configured to determine whether each primitive of the set of surviving primitives is visible in a bin. To this end, visibility circuitry 360 is configured to perform one or more bounding box operations based on the primitive data. For example, visibility circuitry 360 performs one or more bounding box operations based on vertex shading data associated with the vertices of the primitives of the set of surviving primitives. For each primitive of the set of surviving primitives determined to be visible in a bin, visibility circuitry 360 provides visible primitive data (e.g., visible primitive data 335) to fragment shader 358 included in or otherwise connected to (e.g., via bus 112) to APU 114. Such visible primitive data, for example, includes, for example, data indicating an identifier for each visible primitive, vertex shading data (e.g., vertex shading data 315) associated with the vertices of the visible, or both. Further in some embodiments, at step 415, APU 114, visibility circuitry 360, or both provide data indicating index buffer 126 to fragment shader 358.

At step 420, in response to receiving the visible primitive data, data indicating index buffer 126, or both from visibility circuitry 360, fragment shader 358 is configured to generate attribute shading data (e.g., attribute shading data 345) for the visible primitives (e.g., for the vertices of the primitives visible in a bin). As an example, at step 420, fragment shader 358 is configured to first identify one or more vertices, attributes, or both associated with the visible primitives from index buffer 126. To this end, in embodiments, based on the visible primitive data (e.g., primitive identifiers) received from visibility circuitry 360, fragment shader 358 identifies one or more vertices, attributes, or both of the visible primitives from index buffer 126. Fragment shader 358 then performs one or more attribute shading operations using the identified vertices, identified attributes, or both to generate attribute shading data (e.g., data resulting from the performance of the attribute shading operations) for the visible primitives.

In embodiments, method 400 is implemented in a first pass (e.g., visibility pass) of a two-level binning operation, a second pass (e.g., rendering pass) of a two-level binning operation. To this end, in some embodiments, during a second pass of a two-level binning operation, example method 400 includes step 425. At step 425, fragment shader 358 is configured to perform one or more pixel shading operations to produce pixel values for one or more rasterized primitives visible in a bin based on vertex shading data, attribute shading data, or both associated with the vertices of the rasterized primitives. Using the generated pixel values, the APU then renders the image in the bin.

In some embodiments, the apparatus and techniques described above are implemented in a system including one or more integrated circuit (IC) devices (also referred to as integrated circuit packages or microchips), such as the APU described above with reference to FIGS. 1-4. Electronic design automation (EDA) and computer-aided design (CAD) software tools may be used in the design and fabrication of these IC devices. These design tools typically are represented as one or more software programs. The one or more software programs include code executable by a computer system to manipulate the computer system to operate on code representative of circuitry of one or more IC devices so as to perform at least a portion of a process to design or adapt a manufacturing system to fabricate the circuitry. This code can include instructions, data, or a combination of instructions and data. The software instructions representing a design tool or fabrication tool typically are stored in a computer-readable storage medium accessible to the computing system. Likewise, the code representative of one or more phases of the design or fabrication of an IC device may be stored in and accessed from the same computer-readable storage medium or a different computer-readable storage medium.

A computer-readable storage medium may include any non-transitory storage medium, or combination of non-transitory storage media, accessible by a computer system during use to provide instructions and/or data to the computer system. Such storage media can include, but is not limited to, optical media (e.g., compact disc (CD), digital versatile disc (DVD), Blu-Ray disc), magnetic media (e.g., floppy disc, magnetic tape, or magnetic hard drive), volatile memory (e.g., random access memory (RAM) or cache), non-volatile memory (e.g., read-only memory (ROM) or Flash memory), or microelectromechanical systems (MEMS)-based storage media. The computer-readable storage medium may be embedded in the computing system (e.g., system RAM or ROM), fixedly attached to the computing system (e.g., a magnetic hard drive), removably attached to the computing system (e.g., an optical disc or Universal Serial Bus (USB)-based Flash memory), or coupled to the computer system via a wired or wireless network (e.g., network accessible storage (NAS)).

In some embodiments, certain aspects of the techniques described above may be implemented by one or more processors of a processing system executing software. The software includes one or more sets of executable instructions stored or otherwise tangibly embodied on a non-transitory computer-readable storage medium. The software can include the instructions and certain data that, when executed by the one or more processors, manipulate the one or more processors to perform one or more aspects of the techniques described above. The non-transitory computer-readable storage medium can include, for example, a magnetic or optical disk storage device, solid-state storage devices such as Flash memory, a cache, random access memory (RAM), or other non-volatile memory device or devices, and the like. The executable instructions stored on the non-transitory computer-readable storage medium may be in source code, assembly language code, object code, or other instruction format that is interpreted or otherwise executable by one or more processors.

Note that not all of the activities or elements described above in the general description are required, that a portion of a specific activity or device may not be required, and that one or more further activities may be performed, or elements included, in addition to those described. Still further, the order in which activities are listed are not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

What is claimed is:

1. A processor comprising:
one or more processor cores, wherein at least one processor core of the one or more processor cores is configured to:
identify one or more visible primitives in a bin; and
generate, at a fragment shader of the at least one processor core, attribute shading data based on one or more attributes associated with the one or more visible primitives.

2. The processor of claim 1, wherein the at least one processor core is configured to:
identify one or more attributes from an index buffer based on one or more primitive identifiers associated with the one or more visible primitives.

3. The processor of claim 2, wherein the at least one processor core is configured to:
perform one or more attribute shading operations based on the one or more attributes.

4. The processor of claim 1, wherein the at least one processor core is configured to:
divide a screen space into one or more coarse bins.

5. The processor of claim 4, wherein the at least one processor core is configured to:
cull one or more primitives to produce a set of surviving primitives; and
perform a visibility check for each primitive of the set of surviving primitives.

6. The processor of claim 4, wherein the at least one processor core is configured to:
rasterize the one or more visible primitives; and
render the one or more visible primitives based on the attribute shading data.

7. The processor of claim 1, wherein the at least one processor core is configured to:
generate, at a vertex shader of the at least one processor core, vertex shading data for one or more vertices indicated in an index buffer.

8. A method, comprising:
identifying one or more visible primitives in a bin; and
generating, at a fragment shader, attribute shading data based on one or more attributes associated with the one or more visible primitives.

9. The method of claim 8, further comprising:
identifying one or more attributes from an index buffer based on one or more primitive identifiers associated with the one or more visible primitives.

10. The method of claim 9, further comprising:
performing, at the fragment shader, one or more attribute shading operations based on the one or more attributes.

11. The method of claim 8, further comprising:
dividing a screen space into one or more coarse bins.

12. The method of claim 11, further comprising:
culling one or more primitives to produce a set of surviving primitives; and
performing a visibility check for each primitive of the set of surviving primitives.

13. The method of claim 11, further comprising:
rasterizing the one or more visible primitives; and
rendering the one or more visible primitives based on the attribute shading data.

14. The method of claim 8, further comprising:
generating, at a vertex shader, vertex shading data for one or more vertices indicated in an index buffer.

15. A processing system comprising:
a memory; and
an accelerated processing unit (APU) coupled to the memory, the APU comprising:
a visibility circuitry configured to identify one or more visible primitives in a bin; and
a fragment shader configured to generate attribute shading data based on one or more attributes associated with the one or more visible primitives.

16. The processing system of claim 15, wherein the fragment shader is configured to:
identify one or more attributes from an index buffer based on one or more primitive identifiers associated with the one or more visible primitives.

17. The processing system of claim 16, wherein the fragment shader is configured to:
perform one or more attribute shading operations based on the one or more attributes.

18. The processing system of claim 15, wherein the visibility circuitry is configured to:
perform a visibility check for one or more primitives of a set of surviving primitives in the bin.

19. The processing system of claim 15, wherein the fragment shader is configured to:
rasterize the one or more visible primitives in the bin; and
render the one or more visible primitives in the bin based on the attribute shading data.

20. The processing system of claim 15, wherein the APU further comprises:
a vertex shader configured to generate vertex shading data for one or more vertices indicated in an index buffer.
